(19) United States
(12) Patent Application Publication
(10) Pub. No.: US 2025/0297854 A1
(43) Pub. Date: Sep. 25, 2025

(54) DROP PORT ASSISTED RESONANCE DETECTION SYSTEM FOR A RING ASSISTED MACH-ZEHNDER INTERFEROMETER (RAMZI)

(71) Applicant: MELLANOX TECHNOLOGIES, LTD., Yokneam (IL)

(72) Inventors: Meer Nazmus SAKIB, Santa Clara, CA (US); Jens Smith KJERGAARD, Kastrup (DK); Rasmus Glarborg JENSEN, Smoerum (DK); Yannick Charles J. DE KONINCK, Hofstade (BE)

(73) Assignee: MELLANOX TECHNOLOGIES, LTD., Yokneam (IL)

(21) Appl. No.: 18/611,188

(22) Filed: Mar. 20, 2024

(51) Int. Cl. G01B 11/27

(52) U.S. Cl. CPC G01B 11/272

(57) ABSTRACT

Systems and methods are described herein for drop port assisted resonance detection for ring assisted Mach-Zehnder Interferometers (RAMZI). An example system comprises a ring assisted Mach-Zehnder Interferometer (RAMZI) that includes a Mach-Zehnder Interferometer (MZI) and a ring resonator, a drop port operatively coupled to the ring resonator, and a control circuit operatively coupled to the drop port and the RAMZI. The drop port is configured to capture an optical signal indicative of an output power spectrum of the ring resonator, and the control circuit is configured to tune the RAMZI for spectral alignment between the MZI and the ring resonator based on at least the optical signal.

### TECHNOLOGICAL FIELD

Example embodiments of the present invention relate to a ring assisted Mach-Zehnder interferometer (RAMZI) and, more particularly, to spectral alignment of the components of the RAMZI.

### BACKGROUND

A RAMZI, which is an optical device that combines the features of a ring resonator and a Mach-Zehnder interferometer (MZI), is designed to enhance optical functionalities in applications such as filtering, sensing, and signal processing. For optimal performance, spectral alignment between the resonant wavelengths of the ring resonator and specific regions of the MZI's interference pattern is required, thereby enabling sharp filtering profiles and high crosstalk rejection.

Applicant has identified a number of deficiencies and problems associated with conventional systems and methods for spectral alignment of the components of the RAMZI. Many of these identified problems have been solved by developing solutions that are included in embodiments of the present disclosure, examples of which are described in detail herein.

### BRIEF SUMMARY

Systems and methods are therefore provided for drop port assisted resonance detection for ring assisted Mach-Zehnder Interferometers (RAMZI) for spectral alignment of the components of the RAMZI.

In one aspect, a spectral alignment system is presented. The system comprising: a ring assisted Mach-Zehnder Interferometer (RAMZI) comprising a Mach-Zehnder Interferometer (MZI) and a ring resonator; a drop port operatively coupled to the ring resonator, wherein the drop port is configured to capture an optical signal indicative of an output power spectrum of the ring resonator; and a control circuit operatively coupled to the drop port and the RAMZI, wherein the control circuit is configured to tune the RAMZI for spectral alignment between the MZI and the ring resonator based on at least the optical signal.

In some embodiments, the spectral alignment system further comprises: a photodetector operatively coupled to the drop port, wherein the photodetector is configured to transmute the optical signal into an electrical signal.

In some embodiments, the control circuit is further configured to tune the RAMZI for spectral alignment between the MZI and the ring resonator based on at least the electrical signal.

In some embodiments, the control circuit is further configured to: determine distinct minimums in the output power spectrum of the ring resonator based on the electrical signal, wherein the distinct minimums correspond to resonant wavelengths associated with the ring resonator; and tune the RAMZI based on at least the distinct minimums.

In some embodiments, the spectral alignment between the MZI and the ring resonator is achieved in an instance in which the distinct minimums align with destructive interference points in an output power spectrum of the MZI.

In some embodiments, the photodetector is an on-chip photodetector.

In some embodiments, the drop port has a coupling ratio of around 3% of a total optical power circulating within the ring resonator.

In another aspect, a control circuit for spectral alignment is presented. The control circuit comprising: a processing device; a non-transitory storage device containing instructions that, when executed by the processing device, cause the processing device to: receive, from a photodetector, an electrical signal indicative of an output power spectrum of a ring resonator of a ring assisted Mach-Zehnder Interferometer (RAMZI); determine resonant wavelengths associated with the ring resonator based on at least the electrical signal; and generate a feedback control signal based on at least the resonant wavelengths to actively adjust at least one of a heating element of the ring resonator or a heating element of a Mach-Zehnder Interferometer (MZI) of the RAMZI.

In some embodiments, actively adjusting the heating element of the MZI using the feedback control signal causes a shift in an output power spectrum of the MZI to spectrally align the output power spectrum of the MZI with the output power spectrum of the ring resonator.

In some embodiments, adjusting the heating element of the MZI changes an effective refractive index in a corresponding arm of the MZI, and wherein adjusting the heating element of the ring resonator changes an effective refractive index of the ring resonator.

In yet another aspect, a method for spectral alignment is presented. The method comprises: determining, via a drop port, an output power spectrum of a ring resonator; and tuning, using a control circuit, a RAMZI for spectral alignment between an MZI and the ring resonator based on at least the determined output power spectrum of the ring resonator, wherein the RAMZI comprises the ring resonator and the MZI.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example circuit for spectral alignment of the components of a ring assisted Mach-Zehnder interferometer (RAMZI), in accordance with an embodiment of the present disclosure;

FIG. 2 illustrates an example of control circuitry used for spectral alignment of the components of the RAMZI, in accordance with an embodiment of the present disclosure;

FIG. 3 illustrates an example method for spectral alignment of the components of the RAMZI, in accordance with an embodiment of the present disclosure;

FIG. 4A illustrates an example phase response of a ring resonator across various wavelengths, in accordance with an embodiment of the invention;

FIG. 4B illustrates an example output power spectrum of a drop port coupled to the ring resonator across the various wavelengths, in accordance with an embodiment of the invention;

FIG. 5A illustrates an example implementation of the drop port assisted resonance detection system for the RAMZI with heating elements, in accordance with an embodiment of the invention; and

FIG. 5B illustrates spectral alignment of the ring resonator and the MZI corresponding to the example implementation in FIG. 5A, in accordance with an embodiment of the invention.

### DETAILED DESCRIPTION

### Overview

A Ring-Assisted Mach-Zehnder Interferometer (RAMZI) is an optical device that combines the features of a ring resonator and a Mach-Zehnder Interferometer (MZI). The integration of these two components can offer enhanced optical functionalities and improved performance in various applications, such as filtering, sensing, and signal processing. A ring resonator is a loop-like optical structure that allows light waves to circulate therewithin multiple times. A key characteristic of a ring resonator is its ability to enhance specific wavelengths, known as resonant wavelengths. At these wavelengths, light waves constructively interfere within the ring, leading to a significant build-up in intensity. An MZI is an optical interferometer that splits an incoming light signal into two separate paths and then recombines them, leading to interference effects. The output power from the MZI's ports will vary as a function of the phase difference between the two paths, resulting in a spectral response characterized by interference fringes.

For a RAMZI to function optimally, the MZI and the ring resonator must be spectrally aligned. This means that the resonant wavelengths of the ring resonator should correspond with specific regions of the MZI's interference pattern (e.g., destructive interference points). Proper alignment ensures that the RAMZI can operate with maximal efficiency, exhibiting characteristics such as sharp filtering profiles, increased extinction ratio, improved sensitivity, and high crosstalk rejection.

To aid in achieving and maintaining this spectral alignment, embodiments of the invention introduce a low coupling ratio drop port to the ring resonator of the RAMZI. This drop port captures an output power of the ring resonator across wavelengths, including the resonant wavelengths. The resulting optical signal indicative of the output power spectrum of the ring resonator is then directed to a photodetector, which converts the optical signal into an electrical signal. Even though the frequency response of the RAMZI has a flat top, the electrical signal has distinct minimums that correspond to the resonant wavelengths of the ring resonator. These distinct minimums may serve as a reference for spectral alignment.

With the resonant wavelengths identified, embodiments of the invention introduce a control circuit to actively adjust and maintain the spectral alignment between the MZI and the ring. Using tuners or heaters, the control circuit may effect changes in the effective refractive index in the MZI arms and/or the ring resonator, allowing for fine-tuning of their spectral responses. Such active control ensures that a resonant peak (e.g., a distinct minimum) of the ring resonator aligns with a desired part of the MZI's response (e.g., a destructive interference point), ensuring optimal RAMZI performance even under varying external conditions.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example Spectral Alignment System

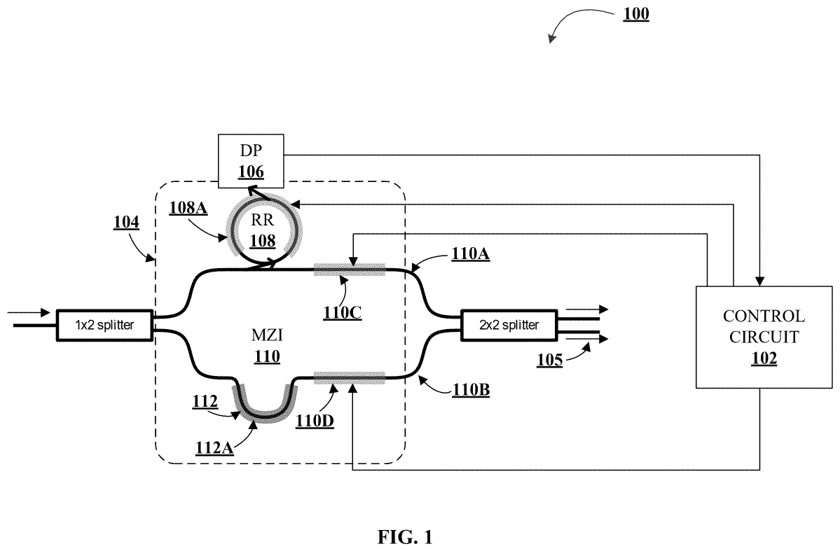

FIG. 1 illustrates an example spectral alignment system 100 for drop port assisted resonance detection for RAMZI, in accordance with an embodiment of the present disclosure. As shown in FIG. 1, the spectral alignment system 100 may include a RAMZI 104 and a control circuit 102.

As shown in FIG. 1, the RAMZI 104 may include a ring resonator (RR) 108, an MZI 110, a drop port (DP) 106, and a half ring resonator 112. The ring resonator 108 may be an optical waveguide having a closed loop structure capable of supporting standing waves at specific resonant wavelengths. In some embodiments, these resonant wavelengths may meet the condition for constructive interference after traversing the loop multiple times. This resonance phenomenon enables the ring to act as a filter, selectively enhancing or suppressing specific wavelengths. The MZI 110 may be an optical interferometer that operates based on the principle of path difference. The MZI 110 may be configured to split an incident optical signal into two MZI arms 110A, 110B, which traverse different optical paths. Upon recombination, the path length difference between the two paths may impart a phase shift between the two beams, leading to interference. The consequent interference pattern may be sensitive to changes in optical path length. The half ring resonator 112 may be used in specialized or custom RAMZIs 104 designed to achieve unique interference characteristics or to fit specific spatial constraints within an integrated photonic circuit. The half ring resonator 112 may be a waveguide positioned on the MZI 110 (e.g., MZI arm 110A, 110B) that forms a semi-circular or partial loop. The half ring resonator 112 may be used to induce a certain phase shift or to interact with the MZI 110 in a manner that differs from the ring resonator 108.

By integrating the ring resonator 108 and MZI 110 (and in some cases, the half ring resonator 112), the RAMZI 104 may allow for the imposition of the resonant condition of the ring resonator 108 onto the interferometric pattern of the MZI 110. Such an interaction permits more precise control over the location of the interference fringes and spacing in the output spectrum, facilitating the creation of complex filter shapes and enhancing the sensitivity of the interferometric measurements. By manipulating the resonances of the ring resonator 108, the effective refractive index seen by the waves in the MZI arms 110A, 110B can be adjusted, thus altering the interference condition in a controllable manner.

For the RAMZI 104 to achieve optimal functionality, the MZI 110 and the ring resonator 108 must be spectrally aligned. In other words, the resonant wavelengths of the ring resonator 108 should correspond with specific regions of the MZI's 110 interference pattern (e.g., destructive interference points). Proper alignment ensures that the RAMZI 104 can operate with maximal efficiency, exhibiting characteristics such as sharp filtering profiles and high crosstalk rejection. To achieve and maintain such a spectral alignment, the drop port 106 may be added to the RAMZI 104. In some embodiments, the drop port 106 may be a low coupling ratio drop port. The drop port 106 may capture a portion of the ring resonator's 108 output power across a spectrum of wavelengths, including resonance wavelengths. The output power, representing the spectral power distribution of the ring resonator 108, may then be routed to a photodetector (not shown). This photodetector may convert the captured optical signal into a corresponding electrical signal. While the frequency response of the RAMZI 104 may appear flat-topped, the electrical signal generated by the photodetector distinctly highlights the minimums that are indicative of the ring resonator's 108 resonant wavelengths. These minimums may be used as reference points for achieving the desired spectral alignment.

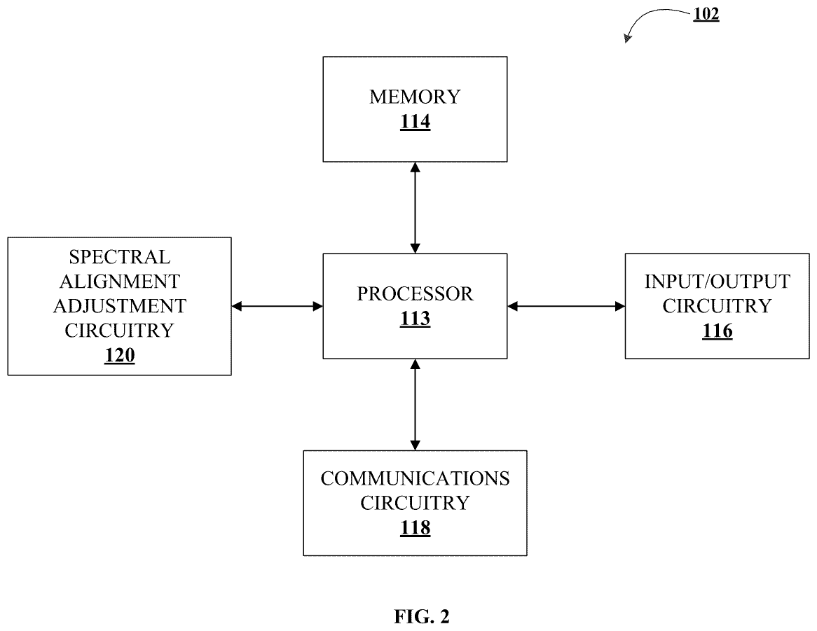

As shown in FIG. 1, the circuit environment of the spectral alignment system 100 may include a control circuit 102 (an example of which is described in further detail below in connection with FIG. 2). The control circuit 102 may communicate with one or more components of the RAMZI 104 (e.g., the ring resonator 108, the MZI 110) to execute embodiments of the invention described herein. The control circuit 102 may be implemented in a number of different forms, for example as an integrated circuit, a microcontroller, a field-programmable gate array (FPGA), or a combination of discrete electronic components. This versatility in implementation allows the control circuit 102 to be customized based on specific application requirements, size constraints, power consumption limitations, and cost considerations. The primary function of the control circuit 102 may include dynamically adjusting the parameters of the RAMZI 104 components, ensuring optimal spectral alignment and performance under varying operating conditions. Additionally, the control circuit 102 may be programmed to monitor feedback signals from the RAMZI 104, enabling it to make autonomous adjustments or alert users to potential issues, thereby enhancing the overall reliability and efficiency of the system.

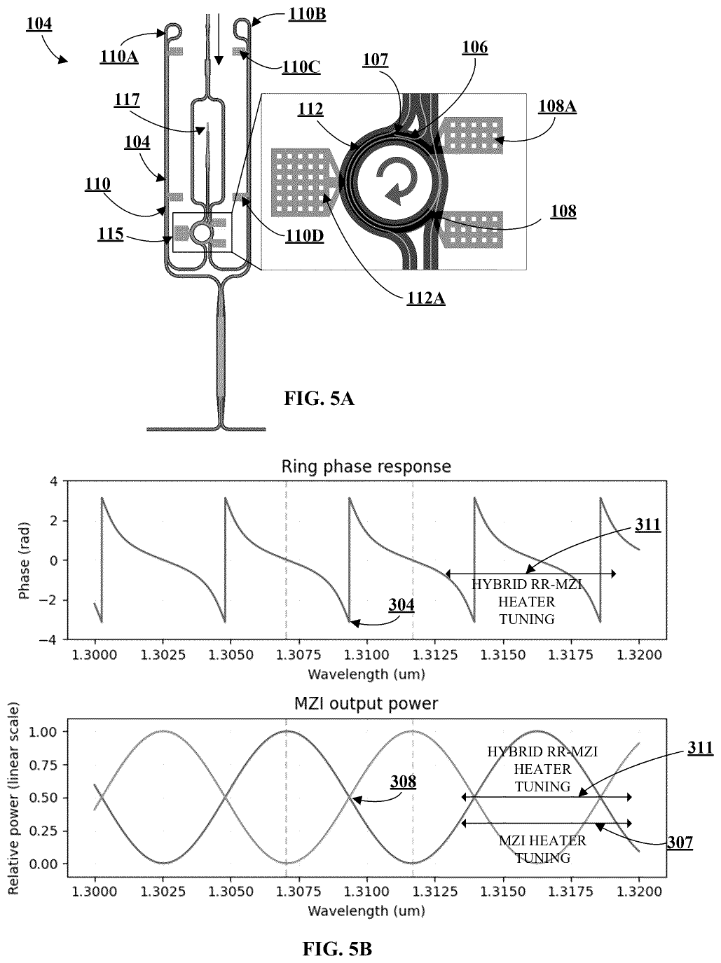

In some embodiments, the control circuit 102 may achieve real-time adjustments to the refractive index of the ring resonator 108, the MZI 110, and/or half ring resonator 112 through thermal tuning. This may involve the application of controlled heat to specific regions of the RAMZI 104 using integrated heating elements (e.g., a thin-film resistor having a temperature that may be adjusted by passing current therethrough). As shown in FIG. 1, the specific regions of the RAMZI 104 may include the ring resonator 108, MZI arms 110A, 110B, and the half ring resonator 112. For example, the ring resonator 108 may include a heating element 108A, the MZI arms 110A and 110B may include heating elements 110C and 110D respectively, and the half ring resonator 112 may include heating element 112A. As described herein, the temperature changes induced by these heating elements can modify the refractive index of the optical paths within the ring resonator 108, the MZI 110, and/or the half ring resonator 112, thus allowing fine-tuning of their spectral characteristics. In some embodiments, the control circuit 102 may be configured to thermally tune the ring resonator 108, the MZI 110, and/or half ring resonator 112 in a coordinated manner through the activation of the heating elements 110C, 110D, 108A, 112A on the respective components. As such, activation of the heating elements 110C, 110D positioned on the MZI arms 110A, 110B, respectively, the heating element 108A positioned on the ring resonator 108, and/or the heating element 112A positioned on the half ring resonator 112 may result in a synchronized shift of both the ring resonator and MZI spectra, as described in more detail in connection with FIGS. 5A-5B.

### Example Control Circuitry

FIG. 2 illustrates a schematic block diagram of example circuitry, some or all of which may be included in the control circuit 102. As shown in FIG. 2, the control circuit 102 may include a processor 113, a memory 114, input/output circuitry 116, communications circuitry 118, and spectral alignment adjustment circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the control circuit 102 may be housed together, while other components may be housed separately (e.g., a controller in communication with the control circuit 102). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the control circuit 102 may provide or supplement the functionality of particular circuitry. For example, the processor 113 may provide processing functionality, the memory 114 may provide storage functionality, the communications circuitry 118 may provide network interface functionality, and the like.

In some embodiments, the processor 113 (and/or co-processor or any other processing circuitry assisting or otherwise associated with the processor) may be in communication with the memory 114 via a bus for passing information among components of, for example, the control circuit 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the control circuit 102, to carry out various functions in accordance with example embodiments of the present disclosure.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the control circuit 102 to carry out various functions in accordance with example embodiments discussed herein. For example, in at least some embodiments, the memory 114 may be configured to buffer data for processing by the processor 113. Additionally, or alternatively, in at least some embodiments, the memory 114 may be configured to store program instructions for execution by the processor 113. The memory 114 may store information in the form of static and/or dynamic information. This stored information may be stored and/or used by the control circuit 102 during the course of performing its functionalities.

The processor 113 may be embodied in a number of different ways and may, for example, include one or more processing devices configured to perform independently. Additionally, or alternatively, the processor 113 may include one or more processors configured in tandem via a bus to enable independent execution of instructions, pipelining, and/or multithreading. The processor 113 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 113 may include a plurality of processors. The plurality of processors may be embodied on a single computing device or may be distributed across a plurality of such devices collectively configured to function as the control circuit 102. The plurality of processors may be in operative communication with each other and may be collectively configured to perform one or more functionalities of the control circuit 102 as described herein.

In an example embodiment, the processor 113 may be configured to execute instructions stored in the memory 114 or otherwise accessible to the processor 113. Alternatively, or additionally, the processor 113 may be configured to execute hard-coded functionality. As such, whether configured by hardware or software methods, or by a combination thereof, the processor 113 may represent an entity (e.g., physically embodied in circuitry) capable of performing operations according to an embodiment of the present disclosure while configured accordingly. Alternatively, as another example, when the processor 113 is embodied as an executor of software instructions, the instructions may specifically configure the processor 113 to perform one or more algorithms and/or operations described herein when the instructions are executed. For example, these instructions, when executed by the processor 113, may cause the control circuit 102 to perform one or more of the functionalities thereof as described herein.

In some embodiments, the control circuit 102 further includes input/output circuitry 116 that may, in turn, be in communication with the processor 113 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like. The input/output circuitry 116 may be used by a user to provide any additional parameters required for achieving and maintaining spectral alignment.

The processor 113 and/or user interface circuitry comprising the processor 113 may be configured to control one or more functions of a display or one or more user interface elements through computer-program instructions (e.g., software and/or firmware) stored on a memory accessible to the processor 113 (e.g., the memory 114, and/or the like). In some embodiments, aspects of input/output circuitry 116 may be reduced as compared to embodiments where the control circuit 102 may be implemented as an end-user machine or other type of device designed for complex user interactions. In some embodiments (as with other components discussed herein), the input/output circuitry 116 may be eliminated from the control circuit 102. The input/output circuitry 116 may be in communication with memory 114, communications circuitry 118, and/or any other component(s), such as via a bus. Although more than one input/output circuitry and/or other component can be included in the control circuit 102, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware, or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, the communications circuitry 118 may be configured to receive and/or transmit any data that may be stored by the memory 114 using any protocol that may be used for communications between computing devices. For example, the communications circuitry 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna (c) to transmit and receive signals. These signals may be transmitted by the control circuit 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the control circuit 102, such as via a bus. The communication circuitry 118 of the control circuit 102 may also be configured to receive and transmit information with the various components associated therewith.

The spectral alignment adjustment circuitry 120, in some embodiments, may be used to maintain the alignment of spectral characteristics between different optical components of the RAMZI, such as a ring resonator and/or an MZI. In some embodiments, the spectral alignment adjustment circuitry 120 may include sensors or detectors that continuously monitor the spectral characteristics of the optical components of the RAMZI, such as by measuring the resonant wavelengths of the ring resonator and the interference pattern of the MZI. Upon measuring the spectral characteristics, the spectral alignment adjustment circuitry 120 may compare the present spectral characteristics with the desired or predefined alignment parameters. Based on the comparison, the spectral alignment adjustment circuitry 120 may generate control signals to adjust the optical properties of the components (e.g., using thermal tuning, as described herein). Once generated, these control signals may be communicated to other components of the control circuit 102, such as the processor 113 for tuning the optical properties of the RAMZI 104. For example, as described herein, the heating elements (e.g., heating element 108A) may be controlled using the spectral alignment adjustment circuitry 120 to regulate the amount of heat applied to ensure that the desired spectral alignment is achieved and maintained consistently. After adjustments are made, the spectral alignment adjustment circuitry 120 may continue to monitor the spectral characteristics of the components to ensure that the alignment remains optimal, or within acceptable tolerances. If further discrepancies are detected, the spectral alignment adjustment circuitry 120 may be configured to determine and direct additional adjustments.

In some embodiments, the control circuit 102 may include hardware, software, firmware, and/or a combination of such components, configured to support various aspects of spectral alignment circuitry as described herein. It should be appreciated that in some embodiments, the spectral alignment adjustment circuitry 120 may perform one or more of such example actions in combination with another circuitry of the control circuit 102, such as the memory 114, processor 113, input/output circuitry 116, and communications circuitry 118. For example, in some embodiments, the spectral alignment adjustment circuitry 120 utilizes processing circuitry, such as the processor 113 and/or the like, to form a self-contained subsystem to perform one or more of its corresponding operations. In a further example, and in some embodiments, some or all of the functionality of the spectral alignment adjustment circuitry 120 may be performed by the processor 113. In this regard, some or all of the example processes and algorithms discussed herein can be performed by at least one processor 113 and/or the spectral alignment adjustment circuitry 120. It should also be appreciated that, in some embodiments, the spectral alignment adjustment circuitry 120 may include a separate processor, specially configured field programmable gate array (FPGA), or application specific interface circuit (ASIC) to perform its corresponding functions.

Additionally, or alternatively, in some embodiments, the spectral alignment adjustment circuitry 120 may use the memory 114 to store collected information. For example, in some implementations, the spectral alignment adjustment circuitry 120 may include hardware, software, firmware, and/or a combination thereof, that interacts with the memory 114 to send, retrieve, update, and/or store data.

Accordingly, non-transitory computer readable storage media, which may, for example, be the memory 114, can be configured to store firmware, one or more application programs, and/or other software, which include instructions and/or other computer-readable program code portions that can be executed to direct operation of the control circuit 102 to implement various operations, including the examples described herein. As such, a series of computer-readable program code portions may be embodied in one or more computer-program products and can be used, with a device, control circuit 102, database, and/or other programmable apparatus, to produce the machine-implemented processes discussed herein. It is also noted that all or some of the information discussed herein can be based on data that is received, generated and/or maintained by one or more components of the control circuit 102. In some embodiments, one or more external systems (such as a remote cloud computing and/or data storage system) may also be leveraged to provide at least some of the functionality discussed herein.

### Example Methods for Allocation of Network Resources

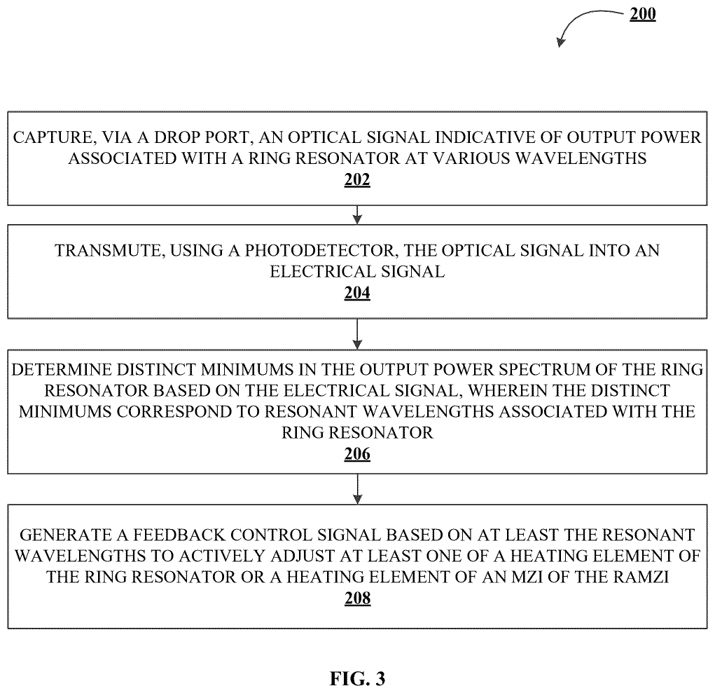

FIG. 3 illustrates an example method 200 for drop port assisted resonance detection for RAMZI, in accordance with an embodiment of the present disclosure. As shown in block 202, the method may capture, via a drop port, an optical signal indicative of output power associated with a ring resonator at various wavelengths. As described herein, the drop port may be used to extract or “drop” an output power of the ring resonator at a specific wavelength or across a range of wavelengths from the circulating optical signal within the ring resonator. In some embodiments, the drop port may have a low coupling ratio. The coupling ratio of a ring resonator may refer to the fraction of the optical signal that is transferred from the ring resonator to the drop port. A low coupling ratio may mean that only a small portion of the optical signal circulating in the ring may be coupled out or “dropped” into the drop port. For example, the drop port may have a coupling ratio of around 3% of the total optical power circulating within the ring resonator.

As shown in block 204, the method may transmute, using a photodetector, the optical signal into an electrical signal. The photodetector may be any device that is capable of converting an optical signal into an electrical signal by absorbing photons from the optical signal and generating an electrical signal proportional to the intensity of the incoming optical signal. The optical signal captured via the drop port may be transformed into an electrical signal using the photodetector. Various types of photodetectors, such as photodiodes, avalanche photodiodes, or phototransistors, may be used depending on the requirements of sensitivity, speed, and wavelength range. The selection of a suitable photodetector may be based on factors such as the wavelength of the optical signal, the required response time, the level of sensitivity needed for accurate conversion of the optical signal into an electrical signal, and/or the like.

As shown in block 206, the method may further determine distinct minimums in the output power spectrum of the ring resonator based on the electrical signal, wherein the distinct minimums correspond to resonant wavelengths associated with the ring resonator. Once the optical signal from the ring resonator has been converted into an electrical signal by the photodetector, the resulting electrical signal may be analyzed to identify particular characteristics of the ring resonator. As described herein, the drop port may be configured to extract a portion of the optical signal from the main path of the ring resonator. When the ring resonator is at resonance, the drop port effectively ‘drops’ or extracts the resonant wavelengths. This action results in the distinct dips or minimums in the output power spectrum at specific locations that correspond to the resonant wavelengths associated with the ring resonator. These distinct minimums may be used as a reference for spectral alignment.

As shown in block 208, the method may also generate a feedback control signal based on at least the resonant wavelengths to actively adjust at least one of a heating element of the ring resonator or a heating element of an MZI of the RAMZI. In some embodiments, the MZI may be spectrally aligned with the ring resonator in an instance in which the distinct minimums in the electrical signal, which correspond to resonant wavelengths of the ring resonator, align with destructive interference points in the output power spectrum of the MZI. This alignment may be achieved by manipulating the optical properties of an optical device (e.g., the MZI, the ring resonator, the half ring resonator, and/or the like), such as by adjusting via the control circuit (described herein) a corresponding heating element positioned on the optical device being adjusted (e.g., on either or both MZI arms, on the ring resonator, on the half ring resonator, and/or the like). Such an adjustment may be based on the principle of thermo-optic effect, which states that changes in the temperature affects the refractive index of the material used in the optical devices.

For instance, the heating element of the MZI may be adjusted to spectrally align the MZI with the ring resonator. In an MZI, as the temperature of the waveguide in one arm of the MZI increases, the refractive index of the MZI changes, affecting the phase of the optical signal traveling through that MZI arm. When the optical signals from both MZI arms are recombined, this phase shift causes a change in the interference pattern. Depending on the extent of the phase shift, the interference can be constructive or destructive at different points, altering the intensity of the output optical signal. On the other hand, the heating element of the ring resonator may be adjusted to spectrally align the MZI with the ring resonator. In a ring resonator, if the temperature of the resonator structure is increased, the refractive index within the ring resonator may change. This change affects the condition for resonance within the ring resonator. Said differently, as the refractive index changes with temperature, so do the resonant wavelengths. The optical signal at these adjusted resonant wavelengths may constructively interfere within the ring, leading to an increase in the intensity of the optical signal at these wavelengths. Conversely, the optical signal at wavelengths that no longer meet the resonance condition will experience less constructive interference, leading to a decrease in their intensity. This temperature-induced shift in resonant wavelengths may result in a change in the spectral output of the ring resonator. In some embodiments, both the heating element of the ring resonator and the heating element of the MZI may be adjusted for spectral alignment. By simultaneously adjusting the heating elements in the MZI arms and the ring resonator, the phase relationship between the optical signal paths in the MZI and the resonance condition in the ring may be more finely tuned to achieve spectral alignment. When properly aligned, the spectral congruence between the distinct minimums of the drop port signal and the destructive interference points of the MZI facilitates the RAMZI to operate at its peak efficiency.

Although the herein described alteration in temperature within the optical component is attributed to an adjustment in the setting of a corresponding heating element, it should be recognized by one skilled in the art, in light of this disclosure, that the temperature may be manipulated through various alternative methods.

### Example Correlation of Resonance Wavelengths of the Ring Resonator and Distinct Minimums Captured by the Drop Port

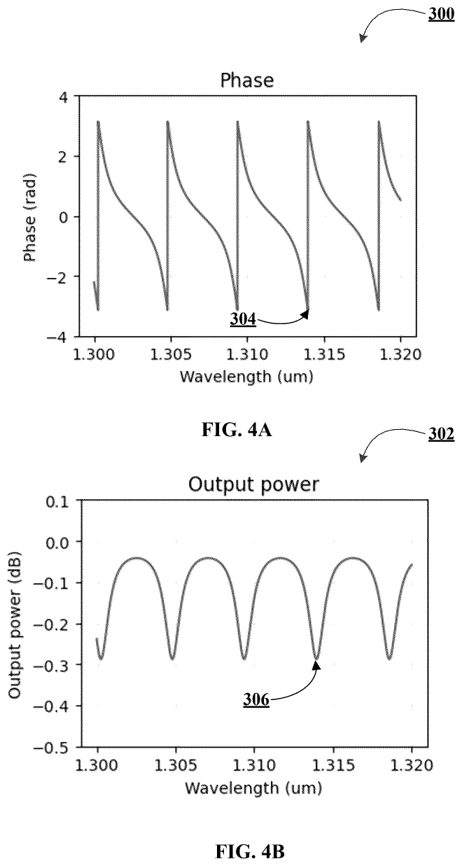

FIG. 4A illustrates an example phase response of the ring resonator 300 across various wavelengths, in accordance with an embodiment of the invention. As shown in FIG. 4A, the resonant wavelengths are indicated by the wavelengths where the phase experiences a rapid transition through a 2π radian shift. This shift corresponds to a full oscillation in the phase of the wave, which is indicative of resonance in the ring resonator. The points of steepest phase transitions 304 in the phase response correspond to these resonant conditions. Here, the transitions—where the phase drops from a high to a low value, often through zero—indicate that the optical signal has completed a full round trip in the ring resonator's loop. The specific wavelengths at which these transitions occur are the resonant wavelengths of the ring resonator. At these wavelengths, the optical signal is in resonance within the ring. Therefore, the minimum points 304 in the phase response 300 may serve as markers for the resonant wavelengths.

FIG. 4B illustrates an example output power spectrum 302 of the drop port coupled to the ring resonator across the various wavelengths, in accordance with an embodiment of the invention. As shown in FIG. 4B, the minimums 306 in the output power spectrum 302 may correspond to these resonant wavelengths 304 (shown in FIG. 4A) of the ring resonator. At these points, although the internal resonance leads to a build-up of energy inside the ring, the transmitted or output power reaches a minimum because most of the energy is confined within the resonator and not transmitted to the output. As described herein, the drop port may be configured to extract a portion of the optical signal from the main path of the ring resonator. When the resonator is at resonance, the drop port effectively ‘drops’ or extracts the resonant wavelengths. This action results in the minimums 306 observed in the output power spectrum, as the power at these wavelengths is being removed from the main transmission path and directed to the drop port. These distinct minimums 306 may be used as a reference to achieve spectral alignment between the ring resonator and the MZI.

### Example Implementation of the Drop Port Assisted Resonance Detection System for a RAMZI

FIG. 5A illustrates an example implementation of the drop port assisted resonance detection system for the RAMZI 104 with heating elements, in accordance with an embodiment of the invention. As shown in FIG. 5A, the RAMZI 104 may include a ring resonator 108, an MZI 110, a drop port (DP) 106, and a half ring resonator 112. As described herein, the ring resonator 108 may have a closed loop structure capable of supporting standing waves at specific resonant wavelengths that meet the condition for constructive interference after traversing the loop multiple times. When the optical signal arrives at the ring resonator 108, at least a portion of the optical signal is coupled into the closed loop structure. Once inside the ring, the optical signal may circulate in a clockwise direction (as shown in FIG. 5A). The extent of this circulation may be governed by the resonant condition of the ring. As described herein, only wavelengths that are resonant with the natural frequencies of the ring resonator 108 can sustain prolonged circulation therewithin.

As described herein, the drop port 106 may be a low coupling ratio drop port that may capture a portion of the ring resonator's 108 output power across a spectrum of wavelengths, including resonance wavelengths. As shown in FIG. 5A, the drop port 106 may be open ended, where one end of the drop port 106 is operatively coupled to the photodetector 117 while the other end 107 of the drop port 106 remains unterminated. The output power, representing the spectral power distribution of the ring resonator 108, captured by the drop port 106 may then be routed to a photodetector 117. The photodetector 117 may convert the captured optical signal into a corresponding electrical signal. In specific embodiments where the optical signal circulates in a counter-clockwise direction, the open end 107 of the drop port 106 may be operatively coupled to a second photodetector (not shown) to capture a portion of the ring resonator's 108 output power. While the frequency response of the RAMZI 104 may appear flat-topped, the electrical signal generated by the photodetector 117 distinctly highlights the minimums that are indicative of the ring resonator's 108 resonant wavelengths. These minimums may be used as reference points for achieving the desired spectral alignment.

As described herein, the MZI may be spectrally aligned with the ring resonator in an instance in which the distinct minimums in the electrical signal, which correspond to resonant wavelengths of the ring resonator, align with destructive interference points in the output power spectrum of the MZI. This spectral alignment may be achieved by applying controlled heat via the control circuit (described herein) to specific regions of the RAMZI 104 using integrated heating elements (e.g., a thin-film resistor having a temperature that may be adjusted by passing current therethrough).

As shown in FIG. 5A, the ring resonator 108 may include a heating element 108A, the MZI arms 110A and 110B may include heating elements 110C and 110D respectively, and the half ring resonator 112 may include heating element 112A. The heating elements 112A and 108A may form a hybrid ring resonator and MZI heating element 115. In specific embodiments, the output power spectrum of the MZI may be tuned through application of heat on the MZI arms 110A, 110B via the corresponding heating elements 110C, 110D. Alternatively or additionally, in specific embodiments, the output power spectrum of the MZI 110 may further be tuned through application of heat on the half ring resonator 112 positioned on the MZI 110 via the corresponding heating element 112A. Alternatively or additionally, the phase response of the ring resonator 108 may be tuned through application of heat on the ring resonator 108 via the corresponding heating elements 108A. Alternatively or additionally, the phase response of the ring resonator 108 and the output power spectrum of the MZI 110 may be thermally tuned for absolute alignment using the hybrid ring resonator and MZI heating element 115.

FIG. 5B illustrates spectral alignment of the ring resonator and the MZI corresponding to the example implementation in FIG. 5A, in accordance with an embodiment of the invention. FIG. 5B illustrates a plot for the phase response of the ring resonator 108 and a plot for the output power spectrum of the MZI 110. Specifically, the phase response of the ring resonator 108 illustrates a change in the phase (in radian) of the ring resonator as a function of wavelength (in micrometer). At resonant wavelengths, the phase of the ring resonator 108 may experience steep phase transitions 304. Also, FIG. 5B, illustrates a plot for the output power spectrum of the MZI 110 as function of relative power (in a linear scale) across various wavelengths (in micrometer). As shown in FIG. 5B, the output power spectrum of the MZI 110 exhibits a series of alternating constructive and destructive interference points, forming an interference pattern of peaks and troughs.

In some embodiments, thermally tuning the heating element 108A (of the ring resonator 108) affects a shift in the phase response of the ring resonator. Similarly, when the heating elements 110C, 110D of the MZI arms 110A, 110B are thermally tuned, the output power spectrum of the MZI 110 shifts horizontally, as indicated by doubled-edged arrow 307. In addition, thermally tuning the heating element 112A (of the half ring resonator 112) affects a shift in the output power spectrum of the MZI. In certain example embodiments, the hybrid ring resonator and MZI heating element 115 may be additionally thermally tuned to refine the absolute spectral alignment between the ring resonator 108 and the MZI 110. This precise thermal tuning may prompt a concurrent horizontal shift in both the phase response of the ring resonator 108 and the output power spectrum of the MZI 110, as indicated by doubled-edged arrow 311, demonstrating the capacity for bidirectional tuning to achieve and maintain optimal spectral alignment.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A spectral alignment system, comprising:
a ring assisted Mach-Zehnder Interferometer (RAMZI) comprising a Mach-Zehnder Interferometer (MZI) and a ring resonator;
a drop port operatively coupled to the ring resonator, wherein the drop port is configured to capture an optical signal indicative of an output power spectrum of the ring resonator; and
a control circuit operatively coupled to the drop port and the RAMZI, wherein the control circuit is configured to tune the RAMZI for spectral alignment between the MZI and the ring resonator based on at least the optical signal.

2. The spectral alignment system of claim 1, further comprising:
a photodetector operatively coupled to the drop port, wherein the photodetector is configured to transmute the optical signal into an electrical signal.

3. The spectral alignment system of claim 2, wherein the control circuit is further configured to tune the RAMZI for spectral alignment between the MZI and the ring resonator based on at least the electrical signal.

4. The spectral alignment system of claim 3, wherein the control circuit is further configured to:
determine distinct minimums in the output power spectrum of the ring resonator based on the electrical signal, wherein the distinct minimums correspond to resonant wavelengths associated with the ring resonator; and
tune the RAMZI based on at least the distinct minimums.

5. The spectral alignment system of claim 4, wherein the spectral alignment between the MZI and the ring resonator is achieved in an instance in which the distinct minimums align with destructive interference points in an output power spectrum of the MZI.

6. The spectral alignment system of claim 2, wherein the photodetector is an on-chip photodetector.

7. The spectral alignment system of claim 1, wherein the drop port has a coupling ratio of around 3% of a total optical power circulating within the ring resonator.

8. A control circuit for spectral alignment, comprising:
a processing device;
a non-transitory storage device containing instructions that, when executed by the processing device, cause the processing device to:
receive, from a photodetector, an electrical signal indicative of an output power spectrum of a ring resonator of a ring assisted Mach-Zehnder Interferometer (RAMZI);
determine resonant wavelengths associated with the ring resonator based on at least the electrical signal; and
generate a feedback control signal based on at least the resonant wavelengths to actively adjust at least one of a heating element of the ring resonator or a heating element of a Mach-Zehnder Interferometer (MZI) of the RAMZI.

9. The control circuit of claim 8, wherein determining the resonant wavelengths further comprises determining distinct minimums in the output power spectrum of the ring resonator based on the electrical signal, wherein the distinct minimums correspond to the resonant wavelengths associated with the ring resonator.

10. The control circuit of claim 9, wherein actively adjusting the heating element of the MZI using the feedback control signal causes a shift in an output power spectrum of the MZI to spectrally align the output power spectrum of the MZI with the output power spectrum of the ring resonator.

11. The control circuit of claim 10, wherein the output power spectrum of the MZI is spectrally aligned with the output power spectrum of the ring resonator in an instance in which the distinct minimums align with destructive interference points in the output power spectrum of the MZI.

12. The control circuit of claim 8, wherein adjusting the heating element of the MZI changes an effective refractive index in a corresponding arm of the MZI, and wherein adjusting the heating element of the ring resonator changes an effective refractive index of the ring resonator.

13. The control circuit of claim 8, wherein the ring resonator is operatively coupled to a drop port, wherein the drop port is configured capture an optical signal indicative of the output power spectrum of the ring resonator.

14. The control circuit of claim 13, wherein the photodetector is configured to transmute the optical signal into the electrical signal.

15. A method for spectral alignment, comprising:
determining, via a drop port, an output power spectrum of a ring resonator; and
tuning, using a control circuit, a RAMZI for spectral alignment between an MZI and the ring resonator based on at least the determined output power spectrum of the ring resonator,
wherein the RAMZI comprises the ring resonator and the MZI.

16. The method of claim 15, wherein determining the output power spectrum comprises capturing an optical signal indicative of output power associated with the ring resonator at various wavelengths.

17. The method of claim 16, further comprising:
transmuting, using a photodetector, the optical signal into an electrical signal.

18. The method of claim 17, wherein tuning the RAMZI for spectral alignment between the MZI and the ring resonator comprises:
determining distinct minimums in the output power spectrum of the ring resonator based on the electrical signal, wherein the distinct minimums correspond to resonant wavelengths associated with the ring resonator; and
generating a feedback control signal based on at least the resonant wavelengths to actively adjust at least one of a heating element of the ring resonator or a heating element of an MZI of the RAMZI.

19. The method of claim 18, wherein the spectral alignment between the MZI and the ring resonator is achieved in an instance in which the distinct minimums align with destructive interference points in an output power spectrum of the MZI.

20. The method of claim 18, wherein the drop port has a coupling ratio of around 3% of a total optical power circulating within the ring resonators.
